(19) United States
(12) Patent Application Publication
(10) Pub. No.: US 2026/0118166 A1
(43) Pub. Date: Apr. 30, 2026

(54) METHOD AND SYSTEM FOR MEASURING THE INFLUENCE OF TURBULENT DISTURBANCES ON A LASER IRRADIATION OF A NON-COOPERATIVE TARGET PASSING THROUGH A TURBULENT ATMOSPHERE

(71) Applicant: MBDA Deutschland GmbH, Schrobenhausen (DE)

(72) Inventor: Jürgen ZOZ, Friedberg (DE)

(21) Appl. No.: 19/370,547

(22) Filed: Oct. 27, 2025

(30) Foreign Application Priority Data
Oct. 28, 2024 (DE) 102024003548.6

(51) Int. Cl. G01J 1/42; F41H 13/00

(52) U.S. Cl. CPC G01J 1/4257; F41H 13/005

(57) ABSTRACT

A method for measuring the influence of turbulent disturbances on laser irradiation of a target passing through a turbulent atmosphere including: focusing a measurement laser beam on the target by an optical device; collimating a laser beam reflected back from the target due to the irradiation and received by the optical device in a sensor plane of a sensor device; repeated measurement of a location-dependent gradient field of a wavefront of the collimated reflection laser beam in the sensor plane, wherein the measurement laser beam is adapted after each measurement such that the individual measurements are statistically independent of one another; and averaging the measured gradient field over the individual measurements to estimate a turbulence disturbance of the measurement laser beam, wherein an associated turbulence-disturbed wavefront is reconstructed from the averaged gradient field by digital signal processing.

### RELATED APPLICATION

This application incorporates by reference and claims priority to German patent application DE 102024003548.6, filed Oct. 28, 2024.

### FIELD OF INVENTION

The present invention relates to a method and system for measuring the influence of turbulent disturbances on laser radiation of a target passing through a turbulent atmosphere.

### BACKGROUND

The effect of a high-energy laser weapon (HEL weapon) on a target to be combated is determined not only by the laser power but also, and to a decisive extent, by the spot diameter and the intensity of the laser beam on the target. As a result of air turbulence, the spot diameter of the laser beam on the target can be significantly increased, which can have a fundamental effect on the targeting effect of the laser beam. For example, in such a case it may be necessary to increase the irradiation time in order to achieve an effect comparable to that of negligible turbulence.

The effects of turbulence on a laser beam can in principle be divided into two portions, the so-called tip/tilt portion, which describes a turbulence-generated migration of the laser spot centroid, and the portion of the so-called higher-order turbulence (abbreviated as turbulence hO in the following), which can lead to smearing and/or to a broadening of the laser spot. The measurement and compensation of the migration of the laser spot centroid are typically easy to handle with suitable methods, so that a migration of the laser spot centroid on the target can normally be sufficiently suppressed.

In order to reduce the effects of turbulence hO on the spot diameter, there could, in principle, be used the so-called adaptive optics based on astronomy or optical telecommunications. For example, the turbulence could be determined directly or indirectly and the output beam built thereon with an appropriate pre-distortion using a conjugate (reversed) wavefront in order to compensate for the turbulent disturbances in the beam propagation to the target as far as possible.

On the one hand, the wavefront disturbed in a turbulent manner could be measured directly to this end. If, for example, a punctiform light source were attached to the target, this punctiform light source could be imaged onto a suitable wavefront sensor such as a Hartmann-Shack sensor. Compensation could then be implemented using a mechanically movable and deformable mirror.

On the other hand, a direct measurement could be dispensed with by instead determining a quality measure for the turbulence-disturbed spot, e.g. the intensity of the spot, and readjustment of the wavefront of the focused laser until an optimum of the quality measure, and thus to a certain extent indirectly a compensating conjugate wavefront, is found. In this case, the technologically complicated and dynamically possibly restricted mirror approach could be dispensed with. For such a method, however, the target would have to be equipped with a retroreflector, for example, in order to obtain a clear quality measure.

For the methods described above, the targets therefore require either an actively radiating point source and/or an additional element for quality measurement, e.g. a retroreflector. Since targets that are combated with a HEL weapon generally do not possess these elements, the application of these methods appears rather difficult. For this reason, targets of this kind are referred to below as non-cooperative targets.

A key difference in the application of turbulence compensation methods in HEL weapon systems, as compared to the known and implemented applications in astronomy and laser-assisted communication, is thought to be that neither a natural measure of quality for the beam diameter on the target nor an ideal point source as in astronomy are available. If a spot is generated on the target by means of a measurement laser and/or the high-energy laser, the result is not a point source but a spot with finite extent affected by diffraction and turbulence, which is reflected by the generally rough surface of the target. As a result, in addition to the turbulent wavefront disturbances to be measured, so-called speckle effects can also occur during back propagation, which can lead to additional wavefront errors not caused by turbulence in a collimated reception plane of the HEL weapon. The finite spot expansion and the speckle effects caused by the target roughness therefore have an influence on wavefront measurements of the turbulence, which makes conventional measurement methods, e.g. based on a Hartmann-Shack sensor, inaccurate.

In general, it should be noted that luminous phenomena may occur due to the interaction of the laser beam with the material of the target, hereinafter referred to as process lights, which, due to their beam intensity, may influence the measurement of a wavefront sensor or the determination of a quality measure to a greater or lesser extent. Furthermore, the surface of the target can be altered by the high-energy laser beam, which in turn can affect the reflectivity for measurement with a wavefront sensor or for determining a quality measure. These aspects must be taken into account when comparing different wavefront measurement methods.

The prior art document DE 10 2021 001 067 B4 describes a method in which the turbulence hO and its amplitude distribution in a reception plane can be precisely measured and, based thereon, corrected, despite wavefront errors due to a finite spot expansion in combination with a rough surface of the target. To achieve this, a location-dependent phase and, if appropriate, a location-dependent amplitude of a measurement laser beam reflected from the target are measured repeatedly in a number of individual measurements, wherein the measurement laser beam is adapted after each individual measurement in such a manner that the individual measurements are statistically independent of one another. Finally, the measured location-dependent phases and, if appropriate, location-dependent amplitudes are averaged over the number of individual measurements to estimate the turbulence disturbance of the measurement laser beam. The influences of the rough target surface are averaged out, because the reflection of the expanded spot on the rough target surface causes a stochastic change in the wavefront of the reflected beam. The turbulence disturbance estimated in this manner can finally be used for turbulence suppression methods.

### SUMMARY

Against this background, the present invention was conceived as a solution for the precise turbulence measurement and, if appropriate, turbulence correction of laser weapons, which can be realized with the simplest possible measuring setup.

The invention may be embodied as a method for measuring the influence of turbulent disturbances on laser irradiation of a target passing through a turbulent atmosphere is provided. The method comprises focusing a measurement laser beam onto the target with an optical device; collimating a laser beam reflected back from the target due to irradiation with the measurement laser beam and received by the optical device in a sensor plane of a sensor device; repeated measurement of a location-dependent gradient field of a wavefront of the collimated reflection laser beam in the sensor plane in a number of individual measurements, wherein the measurement laser beam is adapted after each individual measurement such that the individual measurements are statistically independent of one another; and averaging the measured gradient field over the number of individual measurements to estimate a turbulence disturbance of the measurement laser beam, wherein an associated turbulence-disturbed wavefront is reconstructed from the averaged gradient field by means of digital signal processing.

Furthermore, a system is provided for measuring the influence of turbulent disturbances on laser irradiation of a target when passing through a turbulent atmosphere. The system comprises a laser device which is configured to generate a measurement laser beam; an optical device which is configured to focus the measurement laser beam on the target, to receive a back-reflected laser beam from the target due to irradiation with the measurement laser beam, and to collimate the back-reflected laser beam in a sensor plane; a sensor device which is configured for repeated measurement of a location-dependent gradient field of a wave front of the collimated reflected laser beam in the sensor plane in a number of individual measurements, wherein the measurement laser beam is adapted after each individual measurement in such a manner that the individual measurements are statistically independent of one another; and a calculation device which is configured to average the measured gradient field over the number of individual measurements and, based thereon, to estimate a turbulence disturbance of the measurement laser beam, wherein an associated turbulence-disturbed wavefront is reconstructed from the averaged gradient field by means of digital signal processing.

An idea on which the present invention is based is to measure precisely and, if appropriate, correct the turbulence hO in the reception plane despite the wavefront error caused by the rough target surface by eliminating possible influences of the target surface by suitable averaging of a number N of measurement results. In this case, the invention provides in particular an approach whose measurement result is not affected by the turbulence-induced spot broadening and the rough target surface.

The conceptual starting point here is the phase and amplitude or intensity averaging method described in DE 10 2021 001 067 B4 (hereinafter referred to as PIMV). In the method described there, in each of N individual measurements, a wavefront of the turbulent-disturbed beam reflected from the target is measured directly on the basis of the associated location-dependent phases and, if appropriate, amplitudes. In contrast, in the present method, the gradient field of the wavefront, i.e., the spatial derivative of the wavefronts, i.e., the differential wavefront, is measured N times and finally an averaged gradient field is determined, from which the associated wavefront, which is disturbed by turbulence, can be subsequently reconstructed using known methods of digital signal processing (hereinafter, the present method is therefore abbreviated as dPIMV). Exactly as in the method of DE 10 2021 001 067 B4, the influence of the rough surface of the target is eliminated during averaging. The reconstructed wavefront can be forwarded to a turbulence compensation system as a measured value for the turbulence.

This modified approach offers the considerable advantage that the system can be implemented with a significantly simpler design. Heterodyne or interferometric receiving sensors are required for direct measurement of the disturbed turbulent wavefront for PIMV. These require a very complex optical design, place high demands on the measurement laser, and are technically very challenging to harden for military applications. In contrast, the optical design for the present dPIMV is much simpler to implement, for example with the aid of a conventional Hartmann-Shack sensor as the sensor device in combination with a fast tip-tilt mirror for adapting the measurement laser beam. Although reconstructing the turbulent wavefront from the averaged gradient field is complex, it can be done using digital signal processing and is easily achievable in real time using known prior art methods. Examples of such methods include: C. Schulze et al., “Wavefront reconstruction by modal decomposition”; G. Dai, “Modal wave-front reconstruction with Zernike polynomials and Karhunen-Loève functions”; R. C. Cannon, “Global wave-front reconstruction using Shack-Hartmann sensors” and K. L. Baker, “Least-squares wave-front reconstruction of Shack-Hartmann sensors and shearing interferometers using multigrid techniques”.

It is also worth mentioning that when implementing PIMV with heterodyne methods, the Doppler effect must be taken into account. This does not play a role in the present dPIMV. Further advantages of dPIMV are that it can be easily used in zero-control turbulence suppression methods and that there are no “unwrapping problems” to solve, as is the case with PIMV.

As with PIMV, the present method is based on the fact that the spot of the measurement laser on the target (without turbulence compensation) is generally significantly larger than a diffraction-limited image. If this broadened spot is reflected on the rough target surface, a stochastic change in the wavefront of the reflected beam occurs. In the receiver, the reflected beam is collimated again. Using a suitable method, the gradient field of the wavefront, i.e. the differential wavefront, of the reflected collimated beam can be measured in the sensor plane or the collimated reception plane. This no longer corresponds to the desired distribution of turbulence as it would be generated by a punctiform light source, but is superimposed by a disturbance caused by the rough surface.

In order to determine the course of the turbulence, N individual measurements are carried out in succession in the present approach. In each individual measurement, the location-dependent spatial derivative of the wavefront of the collimated receiving field is determined. It is assumed that the turbulence is approximately constant during the measurement time of the N partial measurements and that the reflection of the rough surface of the target is approximately constant during an individual measurement. It is further assumed that the reflection of the measurement laser occurs on a surface whose roughness is greater than the wavelength of the measurement laser and that the N partial measurements are statistically independent of each other. The latter can be achieved, for example, by suitably changing the measuring laser spot on the target after each measurement, e.g. by shifting it N times within the isoplanatic angle in such a manner that statistically independent measurements are obtained due to the statistical distribution of the surface roughness. If the N measurements are averaged, the wavefront reconstructed from the averaged gradient field converges toward the desired wavefront hO.

The wavefront is understood here to mean the location-dependent phase profile of the optical field which a spotlight would generate on the target when passing through a turbulent atmosphere in the collimated reception plane. The higher-order wavefront (wavefront hO) thus describes the portion of the wavefront without the linear phase portion (i.e., the tip-tilt portion). Furthermore, it is assumed that the tip-tilt portion of the turbulence is already compensated for in some other way, and that the laser spot on the target therefore no longer shows any centroid migration.
i. For the measurement of the time-changing wavefront hO, the following measurement sequence can therefore be repeated periodically, wherein the period duration is significantly shorter than the change time of the wavefront N individual measurements are carried out within a period. The number N is selected here such that a desired measurement accuracy for the wavefront hO is achieved. A individual measurement can proceed as follows: the measurement laser is focused on the target surface by means of an optical element (e.g. a lens and/or a telescope); the laser beam reflected from the rough target surface is received and collimated by the same optical element; the return collimated receive beam is separated from the transmit beam by a suitable optical element (e.g. a beam splitter or a polarizing beam splitter), and the gradient field of the wavefront of the collimated receive beam is determined using a suitable evaluation sensor, wherein the measured gradient field can be stored for further processing.

After completion of an individual measurement, the transmit beam of the measurement laser is modified by an optical device in such a manner that a further statistically independent measurement can be carried out. This can be achieved, for example, by a tip/tilt displacement which shifts the laser spot of the measurement laser on the target. However, other methods, such as distortion of the transmit beam, are also conceivable.

New individual measurements are carried out until N measurements are reached.

To estimate the wavefront hO, the measured location-dependent gradient fields are averaged after the N individual measurements and the turbulent wavefront is reconstructed from the averaged curve using suitable digital methods. The result is an estimate of the wavefront hO.

The estimation of the wavefront hO can then be used, if appropriate, for turbulence suppression methods.

After the period has elapsed, the measuring process can start anew.

In order to implement the present dPIMV approach in practice, the skilled person can, depending on the application, ensure the following assumptions or preconditions:

A laser with good beam quality, for example, can be considered as a measurement laser.

The time constant for the change in the wavefront hO to be measured should be significantly greater than the measurement time for the N individual measurements, i.e. the measurement rate should be significantly greater than the frequency of change of the turbulence (Greenwood frequency).

The roughness of the target surface should be greater than the wavelength used.

During an individual measurement, the reflections on the rough target surface should be approximately constant.

The propagation time of the light should be taken into account when clocking the method.

The distance between the described device and the target should be known, e.g. by separate measurement.

The generated measuring laser spots should remain within the isoplanatic angle of the wavefront hO to be measured.

The estimation of the wavefront hO can be used in particular to carry out turbulence-suppressing methods for one or more laser beams. For example, the turbulence for a measurement laser beam can also be compensated. In this manner, measurement inaccuracies due to scintillation effects can be reduced by, for example, correspondingly adapting the amplitude profile. It is also possible to compensate the turbulence for an active beam, e.g. of a laser weapon or other application. It is conceivable, for example, that the approach described can also be used in other technical fields, for example in eye surveying, optical telecommunications, for imaging methods with strong turbulence, etc.

Advantageous embodiments and further developments result from the further sub-claims and from the description with reference to the figures.

According to a development, the measurement laser beam can be shifted and/or distorted on the target after each individual measurement in order to make the individual measurements statistically independent of one other.

For example, a tip-tilt device may be used to shift the beam or beams within the isoplanatic angle N times on the target surface. Alternatively or additionally, further changes of the measurement laser beam are also possible, which lead to statistically independent measurements. For example, the measurement laser beam may be suitably distorted by phase changes.

According to a further development, as a sensor device there can be used a Hartmann-Shack sensor.

The sensor device can therefore be implemented cost-effectively using known simple standard solutions.

According to a development, the measurement laser beam can be operated in pulsed manner.

Specifically in this development, the present method avoids difficulties with backscattering and process lights. Since, for both PIMV and dPIMV, the optical transmission and reception channels are preferably identical for reasons of implementation and accuracy, they result in small backscatter in the optical setup for the measurement laser, which can be fed back into the reception channel and interfere with the reception signal. This can be easily avoided by using pulsed measurement lasers and gating the receiving sensor. Another advantage of a gated sensor, e.g., a Hartmann-Shack sensor, is the possibility of suppressing process light that can occur due to laser-material interaction of a high-energy laser. Although pulsed operation also appears conceivable for PIMV in order to suppress backscatter and process light, the necessary optical setup and the requirements for the measurement laser are significantly higher than for dPIMV. In contrast, established components can be used for the implementation of dPIMV.

According to a development, a location-dependent intensity of the collimated reflection laser beam can be measured repeatedly together with the gradient field and finally averaged over the number of individual measurements to estimate a turbulence disturbance of the measurement laser beam.

In this manner, there will be taken into consideration not only the phase profiles, but also the intensity profiles, thus allowing for the entire improvement potential of the present approach to be utilized (e.g., in the case of strong turbulence). As a result, there is possible, among other things, full-field compensation.

According to a development, the target can be irradiated with an active laser beam of a laser weapon. The method can then further comprise adapting the irradiation of the target with the active laser beam depending on the estimated turbulence disturbance in order to compensate for the influence of turbulence.

In this development, the laser beam or beams of a HEL weapon system are thus adapted to suppress turbulence effects. The measurement setup described can thus be used to compensate for turbulence hO in a HEL weapon system. The method allows, in particular, precise measurement of the turbulence-disturbed wavefront in the case of non-cooperative targets (i.e., military, non-instrumented targets), wherein the targets generally have a rough surface. Physically, the bandwidth of the process is only limited by the propagation time of light, and no principal limitations are expected from technical practice either. This method is therefore also suitable for turbulence measurement and suppression in very fast-moving targets, e.g., flying targets in airborne laser applications. In general, the method can be used for both coherent and conventional high-energy laser sources.

Specific implementations for such turbulence corrections in a laser weapon system based on an estimation of the turbulence disturbance can be found, for example, in DE 10 2021 001 067 B4.

According to a development, the active laser beam can be used as a measurement laser beam.

One advantage of this variant is that no additional measurement laser is required apart from the active laser, e.g., a coherently coupled high-energy laser with a tiled aperture. However, in this case, it must be noted that the beam reflection from the target can be influenced by the interaction of the HEL with the target material. Beam splitting and the suppression of scattered radiation, especially within the optics, can also pose a technological challenge. Furthermore, it should be ensured that the total pure measurement time is short in comparison to the beam time required to achieve the effect on the target, because otherwise the time required to destroy the target would increase and turbulence compensation would no longer be justified.

According to a development, the active laser beam can have a different wavelength than the measurement laser beam.

In this case, the active laser and measurement laser would thus be implementable separately, wherein they would be focusable and detectable with the same optical device despite the different wavelength.

According to a development, the active laser beam can be focused within the isoplanatic angle, alongside the measurement laser beam onto a spatially separated region of the target.

In this case, the turbulence measurement is not affected by the interaction of the HEL with the target material. Thanks to the wavelength separation of the HEL and the measurement laser, the dPIMV measurement channel can be much better protected against HEL scattered radiation.

The above embodiments and modifications may be combined with each other in any sensible way. Other possible embodiments, developments and implementations of the invention also include combinations of features of the invention described above or below with respect to the exemplary embodiments, which combinations are not explicitly mentioned. In this respect, the skilled person will in particular also add individual aspects as improvements or additions to the respective basic form of the present invention.

### SUMMARY OF DRAWINGS

The present invention will be explained in more detail below with reference to the exemplary embodiments indicated in the schematic figures. The figures show:

FIG. 1 is a schematic view of a system for measuring the influence of turbulent disturbances on the laser irradiation of a target according to an embodiment of the invention; and

FIG. 2 is a schematic flow chart of a method for measuring the influence of turbulent disturbances by means of the system shown in FIG. 1.

The accompanying figures are intended to provide a further understanding of the embodiments of the invention. They illustrate embodiments and, in connection with the description, serve to explain principles and concepts of the invention. Further embodiments and many of the advantages mentioned result with regard to the drawings. The elements of the drawings are not necessarily shown to scale in relation to one another.

In the figures of the drawing, identical elements, features, and components that have the same function and effect—unless stated otherwise—are each provided with the same reference signs.

### DETAILED DESCRIPTION

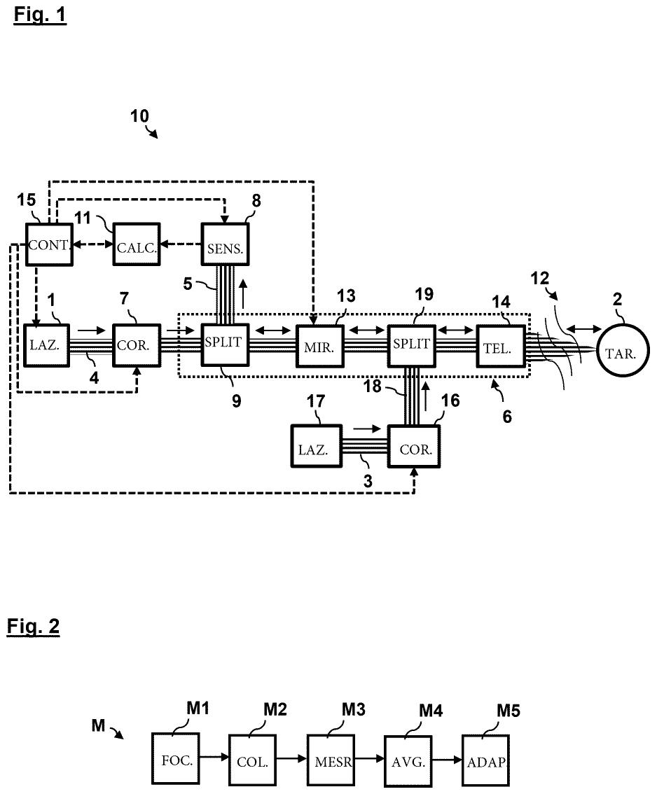

FIG. 1 shows a schematic view of a system 10 for measuring the influence of turbulent disturbances on a laser irradiation of a target 2 when passing through a turbulent atmosphere according to one embodiment of the invention. A corresponding method M is shown as a flowchart in FIG. 2. Here, the variant shown in FIG. 1 follows a generic basic structure of the system 10, which is suitable both for measuring and correcting turbulence-induced wavefront errors.

The system 10 includes a laser device 1, which is configured to generate a (pulsed) measurement laser beam 4. Furthermore, in this configuration the system 10 comprises an active laser device 17 for generating an active laser beam 3. The system 10 is configured as a laser weapon.

The measurement laser beam 4 enters a first correction device 7 and is then directed by an optical device 6 onto the target 2. The optical device 6 can comprise a first beam splitter 9, a deflecting mirror 13 (tip-tilt unit) for moving the measurement laser beam 4 over a target surface of the target 2, a second beam splitter 19 (e.g. a dichroic mirror or the like) for coupling in the active laser beam 3, and a telescope 11, by means of which the measurement laser beam 7 is focused onto the target 2. The measurement laser beam 4 is reflected back from the target 2 and re-enters the optical device 6, which receives this reflected laser beam 5, deflects it via the beam splitter and collimates it in a sensor plane of a sensor device 8.

The sensor device 8 is configured as a Hartmann-Shack sensor for repeatedly measuring a location-dependent gradient field of a wavefront of the collimated reflected laser beam 5 in the sensor plane in a number of N individual measurements. In other words, the differential wavefront of the reflected beam 5 is measured in the sensor plane. In this case, the measurement laser beam 4 is adapted after each individual measurement such that the individual measurements are statistically independent of one another. For this purpose, the measurement laser beam 4 is shifted with the deflecting mirror 13 on the target 2 within the isoplanatic angle (i.e., the deflecting mirror 13 assumes a slightly different position for each individual measurement). In addition to the gradient field, the location-dependent intensity can optionally also be determined in order to improve the accuracy of the turbulence determination.

The measured signals, in particular the currently measured gradient field, are forwarded to a calculation device 11 (e.g. a computer system) which is configured to average the measured location-dependent gradient field over the number of individual measurements (if necessary, supplemented by a corresponding averaging of the measured intensities) and, based thereon, to estimate a turbulence disturbance of the measurement laser beam 4. For this purpose, an averaged differential wavefront is determined from the partial measurements of the differential wavefront, i.e. the individual measurements of the gradient field, from which an associated measured wavefront is then reconstructed using known methods in the literature. This reconstructed (turbulence-disturbed) wavefront is forwarded as a measured value for the turbulence to the correction device 7 for turbulence compensation.

For this purpose, the calculation device 11 is controlled by a control device 15 of the system 10, which, inter alia, can also control the measurement sequence of the system 10, i.e. according to the algorithm described, the laser device 1, possibly the first correction device 7, the sensor device 8 and the optical device 6, in particular the deflecting mirror 13.

In this case, the optional first correction device 7 can be configured to carry out an adaptation of the laser irradiation of the target 2 by the measurement laser beam 4 depending on the estimated turbulence disturbance (e.g. by phase adjustment and possibly an amplitude adjustment) for turbulence compensation. This can lead to an improvement in the measurement of the turbulence disturbance.

A second correction device 16 can be configured in this case to carry out an adaptation of the laser irradiation of the target 2 by the active laser beam 3 depending on the estimated turbulence disturbance for turbulence compensation (e.g. by phase adjustment and possibly an amplitude adjustment). This can be used, for example, to adapt the active laser beam 3 of the laser weapon depending on the estimated turbulence disturbance in order to improve the irradiation quality of the target 2 and thus the effective power of the laser weapon. The influence of turbulence on a measurement laser beam can also be minimized.

The active laser beam 18 corrected in this manner can be coupled into the beam path of the optical device 6 via the second beam splitter 19 and focused on the target 2 by the telescope 14.

In this case, the laser device 1 is operated in a pulsed manner so that the sensor device 8 can be controlled by a suitable gating in order to suppress backscatter in the optical setup, which could otherwise be coupled back into the receive channel due to the identity of the transmit and receive channels and could interfere with the receive signal. The gating can also be used to suppress any process light that may occur due to the irradiation of the target 2 with the active laser beam 3.

The method M schematically shown with reference to FIG. 2 correspondingly comprises, at M1, focusing the measurement laser beam 4 onto the target 2 with the optical device 6. The method M further comprises, at M2, collimating the reflection laser beam 5 reflected back from the target 2 due to the irradiation with the measurement laser beam 4 and received with the optical device 6 in the sensor plane of the sensor device 8. The method M further comprises, under M3, repeated measurement of the location-dependent gradient field of a wavefront of the collimated reflection laser beam 5 in the sensor plane in a number of statistically independent individual measurements. The method M further comprises, under M4, averaging the measured gradient field over the number of individual measurements in order to estimate the turbulence disturbance of the measurement laser beam 4, wherein an associated turbulence-disturbed wavefront is reconstructed from the averaged gradient field by means of digital signal processing. Finally, the method M under M5 may comprise adapting the laser irradiation of the target 2 depending on the estimated turbulence disturbance in order to compensate for the influence of turbulences.

In the foregoing detailed description, various features have been summarized to improve stringency of the representation in one or more examples. However, it should be clear here that the above description is of a purely illustrative, but in no way limiting nature. It is intended to cover all alternatives, modifications, and equivalents of the various features and embodiments. Many other examples will be immediately and immediately apparent to those skilled in the art from the knowledge of the art in view of the above description.

The exemplary embodiments were selected and described in order to be able to best illustrate the principles underlying the invention and their possible applications in practice. This enables those skilled in the art to optimally modify and utilize the invention and its various embodiments with respect to the intended purpose of use. In the claims and the description, the terms “including” and “having” are used as neutral language terminology for the corresponding terms “comprising”. Furthermore, use of the terms “a”, “an” and “one” is not intended to fundamentally exclude a plurality of such described features and components. The term “or” means either or both unless expressly stated otherwise.

### LIST OF REFERENCE SIGNS

1 laser device
2 target
3 active laser beam
4 measurement laser beam
5 collimated reflection laser beam
6 optical device
7 correction device measurement laser
8 sensor device
9 first beam splitter
10 system
11 calculation device
12 turbulent atmosphere
13 deflecting mirror
14 telescope
15 controller
16 correction device active laser
17 active laser device
18 corrected active laser beam
19 second beam splitter
M method
M1-M5 method steps

1. A method for measuring the influence of turbulent disturbances on laser irradiation passing through a turbulent atmosphere, the method comprising:
focusing a measuring laser beam on a target, wherein the laser beam is generated by an optical device;
collimating a reflection laser beam reflected by the target due to irradiation of the target with the measurement laser beam and receiving the reflection laser beam on a sensor plane of a sensor device;
repeatedly measuring a location-dependent gradient field of a wavefront of the collimated reflection laser beam received on the sensor plane in a number of individual measurements, wherein the measurement laser beam is adapted after each of the individual measurements such that the individual measurements are statistically independent of each other; and
averaging the measured location-dependent gradient field over the number of individual measurements to estimate a turbulence disturbance of the measurement laser beam, wherein an associated turbulence-disturbed wavefront is reconstructed from the measured location-dependent gradient field by digital signal processing.

2. The method according to claim 1, wherein the measurement laser beam is shifted or distorted onto the target after each individual measurement to make the individual measurements statistically independent of one other.

3. The method according to claim 1, wherein the sensor device includes a Hartmann-Shack sensor.

4. The method according claim 1, wherein the measurement laser beam is pulsed.

5. The method according to claim 1, wherein, with the gradient field of the wavefront, a location-dependent intensity of the collimated reflection laser beam is repeatedly measured and averaged over the number of individual measurements and used to estimate the turbulence disturbance of the measurement laser beam.

6. The method according to claim 1, wherein the target is irradiated with an active laser beam of a laser weapon, wherein the method further comprises:
adapting the irradiation of the target with the active laser beam depending on the estimated turbulence disturbance to compensate for the turbulence disturbance.

7. A system for measuring influence of turbulent disturbances due to a turbulent atmosphere, the system comprising:
a laser device configured to generate a measurement laser beam;
an optical device configured to focus the measurement laser beam on a target, receive reflections of the measurement laser beam reflected by the target and collimate the reflections on a sensor plane;
a sensor device configured to repeatedly measure a location-dependent gradient field of a wavefront of the collimated reflections in the sensor plane,
wherein the laser device is configured to adjust the measurement laser beam such that the measurements are statistically independent of each other, and
a calculation device configured to generate an averaged gradient filed by calculating an average of the location-dependent gradient fields and estimate a turbulence disturbance due to the turbulence atmosphere of the measurement laser beam,
wherein an associated turbulence-disturbed wavefront is reconstructed by the calculation device from the averaged gradient field.

8. The system according to claim 7, wherein the optical device is configured to shift or distort the measurement laser beam on the target after each individual measurement to make the individual measurements statistically independent of each other.

9. The system according to claim 7, wherein the sensor device is a Hartmann-Shack sensor.

10. The system according to claim 7, wherein the laser device is configured to pulse the measurement laser beam.

11. The system according to claim 7, wherein the sensor device is configured to repeatedly measure a location-dependent intensity of the collimated repeated laser beam, and
wherein the calculation device is configured to average the measured intensities over the number of individual measurements to estimate the turbulence disturbance of the measurement laser beam.

12. The system according to claim 7, wherein the system is a laser weapon that generates an active laser beam for the irradiation of the target, wherein the system further comprises:
a correction device configured to adapt the irradiation of the target with the active laser beam depending on the estimated turbulence disturbance in order to compensate the influence of turbulence.

13. A method comprising:
irradiating a target with a measurement laser beam that passes through the atmosphere to the target;
receiving and collimating a reflection of the laser beam from the target on a sensor plane of a sensor device;
repeatedly measuring a location-dependent gradient field of a wavefront of the reflection by the sensor device;
shifting or distorting the measurement laser beam during the irradiation to ensure that the measurements of the location-dependent gradient fields are statistically independent of each other, and
using the measurements of the location-dependent gradient field to estimate a turbulence disturbance of the measurement laser beam.

14. The method according to claim 13, wherein the measurement laser beam is shifted or distorted onto the target after each of the measurements.

15. The method according to claim 13, wherein the sensor device is includes a Hartmann-Shack sensor and the measurement laser beam is a pulsed beam laser.

16. The method according to claim 13, wherein the using the measurements includes averaging measuring a location-dependent gradient fields to estimate the turbulence disturbance.

17. The method according to claim 13, further comprising:
irradiating the target with an active laser beam of a laser weapon, and
adjusting the irradiation of the target with the active laser beam using estimated turbulence disturbance to compensate for the turbulence disturbance.
